(19) United States
(12) Patent Application Publication
(10) Pub. No.: US 2014/0264012 A1
(43) Pub. Date: Sep. 18, 2014

(54) Portable Field 3He/4He Stable Isotope Detector for Use in Survey Work and Autonomous Monitoring

(71) Applicant: Gary Michael McMurtry, Honolulu, HI (US)

(72) Inventor: Gary Michael McMurtry, Honolulu, HI (US)

(21) Appl. No.: 13/999,641

(22) Filed: Mar. 14, 2014

Related U.S. Application Data
(60) Provisional application No. 61/852,113, filed on Mar. 15, 2013.

(51) Int. Cl. H01J 49/24

(52) U.S. Cl. CPC H01J 49/24
USPC 250/288

(57) ABSTRACT

An instrument is described for measurements of the isotopic abundance of ³He and ⁴He stable isotopes remotely and in near real time. It is designed to work autonomously in the field in harsh environments, and is composed of modestly priced materials, vacuum and electronic subsystems for economical use as a stand-alone instrument. Helium and hydrogen are accumulated into an ultra high vacuum (UHV) through a heated quartz glass window optimized for wall thickness and surface area. Hydrogen isobars that can interfere with helium isotope analysis by mass spectrometry are removed by fast gettering. Automated or manually controlled exposure to noble diode ion pumps is used to clean the UHV after analysis. The ³He/⁴He ratio can be measured in artificial gases and in natural gases such as those in the atmosphere, in the ground or in seeps, wells and deep boreholes, and in dissolved gases in natural and artificial solutions.

### CROSS-REFERENCE TO RELATED APPLICATIONS

“This application claims the benefit of Provisional Patent Application Ser. No. 61/852,113, filed 2013 Mar. 15 by the present inventor.”

### FEDERALLY SPONSORED RESEARCH

Not applicable.

### SEQUENCE LISTING OR PROGRAM

No listing.

### FIELD OF THE INVENTION

The invention pertains to the low-level, time-series determination of ³He and ⁴He stable isotopes in the environment. Calculating the ratio of these isotopes can help to characterize the systematics of deep Earth processes such as crust-mantle interactions, seismicity and earthquake activity of the crust and upper mantle, and the movement of magma beneath the Earth's surface.

### SUMMARY OF THE INVENTION

An instrument design and application method is disclosed that can make precise and sensitive measurements of the isotopic abundance of ₃He and ₄He stable isotopes remotely and in near real time. The instrument is designed to work in the field in harsh environments. Helium and hydrogen are accumulated into an ultra-high vacuum (UHV) through a heated quartz glass window, and hydrogen isobars that may interfere with helium isotope analysis by mass spectrometry are removed by fast gettering. Exposure to noble diode ion pumps is used to clean the UHV after analysis. The isotope ratio of ₃He/₄He can be measured in artificial (e.g., process, waste) gases and in natural gases such as those in the atmosphere, in the ground or in seeps, wells and deep boreholes, and in dissolved gases in natural and artificial solutions. The instrument is rugged, portable, low power, and is capable of autonomous operation with internal recording and/or communication of the data remotely in near real time.

### BACKGROUND OF THE INVENTION

Helium Resources

Helium is the second most abundant element in the universe, after hydrogen. There are only two stable isotopes, ³He and ⁴He. Because of its light mass and noble chemical behavior, the mobility of helium allows its escape from planetary atmospheres like the Earth's, so little original or primordial helium presently exists at the surface. Most helium found near the Earth's surface is produced by the ongoing alpha particle decay of long-lived U and Th with daughter radioisotopes in crustal rocks and sediments, producing ₄He. The far less abundant ³He isotope is only stored as residual primordial helium in the Earth's mantle and core, with some minor additions from solar and cosmic ray spallation production in the upper atmosphere and as absorbed helium enriched in ³He in the Moon's regolith and in interplanetary dust particles (IDP) that are constantly drawn down to Earth's surface from interplanetary space.

Most commercial helium today is produced as a by-product of natural gas production from deep wells in the Amarillo, Tex. national helium reserve. By 2015, the Amarillo national facility's helium gas supply is projected to be totally depleted. New supplies from plants coming on line in late 2012 in Wyoming and in foreign natural gas fields (Russia, Australia and Qatar) will not ease the present supply crisis, and the nation could be faced with recycling and other conservation measures such as rationing. With a shortage on, the price of helium may rise considerably, and many present uses could be curtailed. The rare ₃He gas is used in neutron detectors by the US military, Dept. of Energy and Dept. of Homeland Security (DHS), in oil and gas exploration, and in advanced medical research. One supplier of ₃He we recently contacted, Cambridge Isotope Laboratories, Inc. of Andover, Mass., is quoting it as “currently not available”. Under these developing circumstances, a portable, sensitive sensor capable of detecting both ₃He and ₄He gas could be useful in process monitoring, exploration, and conservation efforts.

Magma and Earthquake Monitoring

Because of the primordial signature of the helium isotope ratio in the Earth's mantle, it has been useful for earth scientists to compare and monitor the ³He to ⁴He mass abundance ratio in rocks, sediments and volatiles such as free gases and those dissolved in water. The R/Ra ratio, where Ra=air ³He/⁴He ratio of 1.4×10⁻⁶, varies from 1 in the atmosphere (by definition) to values <1 in continental rocks that are enriched in U and Th (sources of radiogenic ⁴He), from 0 to 8 in ocean and arc crustal rocks, depending upon age, mixing, and weathering effects, to 8±1 in fresh Mid-Ocean Ridge Basalt (MORB) and volatiles (volcanic gases, hydrothermal fluids) (as described by Poreda, R. J. and Craig, H., 1989, “Helium isotope ratios in cir cum-Pacific volcanic arcs”, Nature 338, 473-478, which is hereby incorporated as reference), to as high as 10-35 in hotspot basalts (gases trapped in glass/vesicles) and in hotspot fumarolic gases and hydrothermal fluids. The higher hotspot values reflect the deep mantle origin of hotspot magma generation (as described by Rison, W. and Craig, H., 1983, “Helium isotopes and mantle volatiles in Loihi Seamount and Hawaiian island basalts and xenoliths”, Earth Planet. Sci. Lett. 66, 407-426, which is hereby incorporated as reference; and by Hilton, D. R., McMurtry, G. M., and Kreulen, R., 1997, “Evidence for extensive degassing of the Hawaiian mantle plume from helium-carbon relationships at Kilauea volcano”, Geophys. Res. Lett. 24, 3065-3068, which is hereby incorporated as reference).

The ³He/⁴He ratio has been shown to be an effective mantle or magma monitor (as described by Sano, Y. and Wakita, H., 1988, “Helium isotope ratio and heat discharge rate in Hokkaido island, northeastern Japan”, Geochem. J. 22, 293-303, which is hereby incorporated as reference; and by Sano, Y., Nakamura, Y., Wakita, H., Urabe, A., and Tominaga, T., 1984, “Helium-3 emission related to volcanic activity”, Science, 224, 150-151, which is hereby incorporated as reference; and by Sano, Y., Nakamura, Y., Notsu, K. and Wakita, H., 1988, “Influence of volcanic eruptions on helium isotope ratios in hydrothermal systems”, Geochim. Cosmochim. Acta 52, 1305-1308, which is hereby incorporated as reference; and by Sakamoto, M., Sano, Y. and Wakita, H., 1992, “³He/⁴He ratio distribution in and around the Hakone volcano”, Geochem. J. 26, 189-195, which is hereby incorporated as reference). A very convincing slow rise in the ³He/⁴He ratio of groundwater following new magmatic activity (earthquakes, seismic tremor) at active Oshima Volcano in Japan was described by Sano, Y., Gamo, T., Notsu, K. and Wakita, H., 1995, “Secular variations of carbon and helium isotopes at Izu-Oshima volcano, Japan”, J. Volcanol. Geotherm. Res. 64, 83-94, which is hereby incorporated as reference. The rise of this ratio in fumarolic gases has also been recorded to follow seismic swarms beneath Mammoth Mountain, Calif. (Long Valley Caldera) associated with underground magma movements there (as described by Sorey, M. L., Kennedy, B. M., Evans, W. C., Farrar, C. D. and Suemnicht, G. A., 1993, “Helium isotope and gas discharge variations associated with crustal unrest in Long Valley Caldera, Calif., 1989-1992”, J. Geophys. Res. 98, 15,871-15,889, which is hereby incorporated as reference). The ³He/⁴He ratio has been useful in delineating buried active fault segments (as described by Umeda, K. and Ninomiya, A., 2009, “Helium isotopes as a tool for detecting concealed active faults”, Geochemistry, Geophysics, Geosystems, 10, doi: 10.1029/2009GC002501, which is hereby incorporated as reference); time-series variations of the ³He/⁴He ratio in well waters were shown to correlate with seismic swarms in non-volcanic areas of Japan (as described by Wakita, H., Sano, Y. and Mizoue, M., 1987, “High ³He emanation and seismic swarm activities observed in a non-volcanic, frontal arc region”, J. Geophys. Res. 92, 12539-12546, which is hereby incorporated as reference) and in 1997-98 along active fault zones in Italy (as described by Italiano, F., Martinelli, G., and Nuccio, P. M., 2001, “Anomalies of mantle-derived helium during the 1997-1998 seismic swarm of Umbria Marche, Italy”, Geophys. Res. Lett., 28, 839-842, which is hereby incorporated as reference; and by Italiano, F., Martinelli, G., and Rizzo, A., 2004, “Geochemical evidence of seismogenicinduced anomalies in the dissolved gases of thermal waters: A case study of Umbria (Central Apennines, Italy) both during and after the 1997-1998 seismic swarm”, Geochemistry, Geophysics, Geosystems, 5, doi:10.1029/2004GC000720, which is hereby incorporated as reference). Large earthquakes, such as the Kobe, Japan earthquake in 1995 may be important mechanisms in the release of He from Earth (as described by Sano, Y., N. Takahata, G. Igarishi, N. Koizumi, and N. C. Sturchio, 1998, “Helium degassing related to the Kobe earthquake”, Chem. Geol., 150, 171-179, doi: 10.1016/S0009-2541(98)00055-2, which is hereby incorporated as reference). More recently, the North Anatolian Fault in Turkey was shown to exhibit ³He/⁴He ratio changes over time thought to be associated with changes in the flow paths of fluids within the fault zone (as described by Dogan, T., Sumino, H. Nagao, K. Notsu, K. Tuncer, M. K. and Celik, C., 2009, “Adjacent releases of mantle helium and soil CO₂ from active faults: Observations from the Marmara region of the North Anatolian Fault zone, Turkey”, Geochemistry, Geophysics, Geosystems, 10, doi:10.1029/2009GC002745, which is hereby incorporated as reference).

Barry et al. (2009) describe a method of helium collection in groundwaters and geothermal fluids called SPARTAH (Barry, R H., Hilton, D. R., Tryon, M. D., Brown, K. M., and Kulongoski, J. T., 2009, “A new syringe pump apparatus for the retrieval and temporal analysis of helium in groundwaters and geothermal fluids”, Geochemistry, Geophysics, Geosystems, 10, doi:10.1029/2009GC002422, which is hereby incorporated as reference). It works upon the principle of slow diffusion of dissolved gases collected in narrow copper tubes over time. This slow diffusion allows recovery of water samples collected in coils of copper tubing using an automatic syringe pump, which are then crimped into labeled sections for later analysis in the laboratory using conventional ³He to ⁴He mass abundance detection. This analysis involves skillful vacuum line extraction and is usually performed with a large noble gas ratio mass spectrometer (MS), such as the Helix SFT made by Thermo Scientific. While such helium collection approaches are useful for advancing knowledge, they do not provide real-time data that could be helpful to hazard mitigation efforts, nor do they provide for changes to the sampling resolution other than that pre-programmed by the water pump speed. The data collection is also limited to dissolved gases. The field instrumentation costs are comparatively modest, but the isotopic data depend upon an established noble gas isotope laboratory for the analyses, which are both costly and labor intensive to produce.

### REFERENCE NUMERALS IN DRAWINGS

1. Overall length of detector housing
2. Length of vacuum components and electronic circuit boards housing
3. Length of sampler housing
4. Outside diameter of detector housing
5. Welded sampler endcap
6. Vacuum bulkhead
7. Removable endcap
8. Gas In port
9. Gas Out port
10. Heater and thermocouple electrical feed-thrus
11. Vacuum purge port to high-vacuum cutoff valve
12. Vacuum port to ion pumps
13. Power connector port
14. Communications connector port
15. Quartz glass cylinder with rounded end
16. Pyrex™ glass coupling
17. Conflat-type cylindrical vacuum flange
18. Outer metal gas-tight case
19. Heater jacket
20. Inner metal cage, with perforations
21. Non-Evaporable Getter (NEG) pump
22. Ultra High Vacuum (UHV)
23. Mass spectrometer
24. High-vacuum cutoff valve (manual)
25. Pressure or hermetically sealed housing
26. Diode ion pump or high-vacuum pressure gauge
27. UHV cutoff valve (manual or automatic)
28. Noble diode ion pump
29. Electronic circuit boards
30. Inside diameter of UHV housing on bulkhead (no. 6)
31. Clamp, adjustable metal
32. Gas flow damper
33. Conflat-type Tee cylindrical vacuum flange
34. UHV pressure gauge
35. Gas flow diffuser, circular, showing four ports on side
36. Gas flow diffuser, circular coil, showing eight turns
37. Outside diameter of glass sample port
38. Through-hole of electrical feed-thru
39. Vacuum weld, 360°
40. High-temperature (to 150° C.) epoxy cement seal
41. Pressure-relief valve
42. Rear chamber mount, metal
43. Custom gasket, high-temperature
44. Threaded mount hole
45. Gasket bolt thru-hole
46. Outside diameter of glass port
47. Inside diameter of diffuser coil
48. Outside diameter of diffuser coil
49. Inside diameter of sample chamber
50. Sealing rear sample chamber assembly
51. Fluid In port
52. Fluid Out port
53. Fluid sample reservoir
54. Fluid and gas tight case, thin-wall metal
55. Thin (few mm) quartz glass tube or glaze
56. Sintered metal (stainless steel, titanium) or ceramic pressure support
57. Drilled or slotted metal inner pressure support
58. Area of fused glass-to-metal seal, 360°
59. Diameter of cylindrical metal sample case
60. Heater element, as coil
61. Temperature sensor, fluid
62. Area of fluid and gas-tight o-ring seal, 360°
63. Circular glass disc of diameter d and thickness n
64. Hollow glass sphere of diameter d and thickness n
65. Hollow glass cylinder of diameter d and thickness n
66. Length h of glass cylinder of diameter d and thickness n
67. Multiple glass cylinders of diameter m and thickness n, where m<d
68. Passageway to UHV
69. Direction of molecular flow from glass ports
70. UltraTorr™ vacuum connector
71. Stainless steel vacuum tubing
72. Elbow tubing connector, stainless steel
73. Tee tubing connector, stainless steel
74. Gas flow direction to pumps
75. Sample, standard in variable length copper tube with one crimped end
76. Manual tubing clamp, gas tight
77. Power cable
78. Communications cable
79. Recirculation pump, gas tight
80. Flexible metal hose, gas tight
81. Accumulation chamber, metal, gas tight
82. Three-way solenoid valve
83. Gas exit to atmosphere
84. Gasket seal
85. Well head temperature, pressure sensors
86. Well head pad
87. Standing groundwater in dug or drilled well
88. Headspace gas in equilibrium with water (no. 87)

### DESCRIPTION OF THE DRAWINGS

FIG. 1. Design sketch of the portable ³He/⁴He stable isotope detector in a preferred embodiment featuring a quartz glass cylinder, closed on one end (cross-sectional view, not to scale).

1a. The detector is a cylindrical design of overall length 1 and diameter 4. It consists of two major sub-compartments: 2 a pressure or hermetically-sealed housing 25 containing the detector vacuum components 21-24, 26-and electronic circuit boards 29; and 3 a sampler housing containing the quartz glass membrane assembly 15-17 and heater jacket 19. The heater jacket surrounds the quartz glass membrane assembly upon an inner metal cage support with perforations for flow 20. An outer metal gas-tight case 18 holds the gas or fluid sample as detailed in FIGS. 3 and 4. Samples enter through a tubular port in the case at 8 and exit at 9. Heater and temperature electrical feed-thrus 10 are located in the center of the welded sampler end cap 5. The entire outer metal case is attached to the pressure or hermetically sealed housing with an adjustable metal clamp 31.

1b. Welded sampler endcap 5 with tubular sample in 8 and out 9 ports and a connector containing the heater and temperature electrical feed-thrus 10.

1c. Vacuum bulkhead 6 containing the UHV vacuum purge port 11, vacuum port to ion pumps 12, port for the NEG assembly 22, and port for the mass spectrometer 23. The dashed circle 30 denotes the inside diameter of the UHV housing.

1d. Removable endcap 7 with electrical feed-thru connector ports for power 13 and communications 14.

FIG. 2. Another preferred embodiment of the portable ³He/⁴He stable isotope detector, showing a vertically-mounted sampler housing. In this design sketch, a gas flow damper 32 is used to adjust the exit gas flow and temperature of the glass membrane. The Conflat-type Tee flange 33 allows additional room for an UHV pressure gauge 34. Sample-in gas flows through a circular diffuser surrounding the quartz glass membrane assembly at the base of the sampler housing 35.

FIG. 3. Detailed view of the sampler housing and quartz glass heater chamber of the portable ³He/⁴He stable isotope detector (cross-sectional view, not to scale). This embodiment is for gas sampling.

3a. A gas-tight metal housing or case 18 of some overall length 3 and diameter 4 contains the gas sample IN 8 and OUT 9 tubular ports and a connector for the heater and temperature electrical feed-thrus 10 inside a through-hole 38 drilled on a welded endcap 5. It can be constructed by two circular metal welds 39 of a pipe or other cylindrical metal piece to the sample endcap 5 and the sealing rear sample chamber assembly 50. In this preferred embodiment, cold sample gas is confined to a spiral of eight metal coils with a series of small egress holes 36 facing the glass window assembly 15-17, outlined as shown 37. The fit of the outside diameter of the glass port 46 with inside 47 and outside 48 diameters of the diffuser coil are shown.

3b. The welded endcap 5 contains high-vacuum, temperature-resistant epoxy cement 40 seals to the gas sample IN 8 and OUT 9 tubular ports. This sealing method is preferred over metal welds if the sampler tubing needs to be removed for periodic cleaning, etc. The endcap also contains a pressure-relief valve 41 to prevent over-pressuring of the sampler housing by introduced sample gas.

3c. The sealing rear sample chamber assembly 50 consists of a metal rear chamber mount 42 and a custom high-temperature gasket 43. The entire gas-tight metal housing is mounted to the outer Conflat-type vacuum flange of the UHV 22 with bolts through threaded mount holes in the metal 42 and thru-holes in the gasket 45. It is designed to attach outside of the maximum inside diameter of the sample chamber 49.

FIG. 4. Detailed view of the sampler housing and quartz glass heater chamber of the portable ³He/⁴He stable isotope detector (cross-sectional view, not to scale). This embodiment is for fluid sampling from ambient to high pressures. Fluids are pumped by external means into the housing through the fluid IN port 51 and exit through the fluid OUT port 52. The fluid sample reservoir 53 is confined by the fluid and gas-tight case, in relatively thin-wall metal (stainless steel or titanium) 54 by means of external solenoid valves (not shown), or can be free-flowing. The glass port assembly consists of a thin (few mm) quartz glass tube or glaze coating 55 over a porous sintered metal (stainless steel or titanium) or ceramic pressure support 56. The porous glass support is further supported by an inner metal cylinder, which contains drilled or slotted thru-holes for gas passage 57, thus allowing relatively high hydrodynamic pressures. The glass port assembly is thermally sealed to the Conflat-type metal vacuum flange 17 at 58 in a circular manner and the entire sampler housing 54 of specified length 3 and diameter 59 is sealed by radial o-rings to the (reinforced) vacuum housing at 62. A heater element as coil 60 allows for specified fluid heating controlled by a thermostat and measured by an internal fluid temperature sensor 61. Waterproof electrical leads for the heater and sensor are routed through a feed-thru connector 10.

FIG. 5. Geometrical considerations for the optimal surface collection area of a quartz glass helium accumulator chamber window. A=area, d=diameter, r=radius, h=length, n=constant thickness. Units of inches are used (1 in.=2.54 cm).

5a. A circular glass disc of diameter d and thickness n (63). Given d=3.0 inch, r=1.5 inch, A=πr²=7.065 in²

5b. A hollow glass sphere of diameter d and thickness n (64). A=4πr²=28.26 in²

5c. A hollow cylinder of diameter d (65), length h (66) and thickness n. Given d=3.0 inch, r=1.5 inch, h=6.0 inch, A=2πr²+2πrh=14.13+56.52=70.65 in²

5d. A set of multiple hollow cylinders of diameter m<d 67, length h 66 and thickness n. Given d=1.0 inch, r=0.50 inch, h=6.0 inch×4 tubes in parallel, A=4[2πr²+2πrh]=4[6.28+37.68]=175.84 in²

Hollow glass tubes in 5b-5d indicate passageways to UHV 68. Arrows indicate direction of molecular flow from glass ports 69. Scaling factors relative to the area of the circular disc are:

Disc: 1

Sphere: 4

Cylinder: 10

Multiple cylinders (4): 25

Multiple cylinders (8): 50

FIG. 6. Detailed view of the UHV cutoff valve portion of the portable ³He/⁴He stable isotope detector, showing a small standard or sample addition scheme to the UHV (cross-sectional view, not to scale). Outside of the high-vacuum cut-off valve 24, an UltraTorr™ valve 70 is used to connect stainless steel tubing 71 to the UHV that contains a stainless steel Elbow 72 and Tee 73. One tubing direction from the Tee goes to the pumps 74 with another high-vacuum cutoff valve 24. One tubing direction from the Tee goes to the sample, standard in a variable length of copper tubing with one crimped end 75 that is attached with another UltraTorr™ valve 70 and contains a sealed, manual, gas-tight tubing clamp 76.

FIG. 7. Flow chart of the major operational steps a to o for the portable, autonomous, realtime ³He/⁴He stable isotope detector. A programmed embedded computer and a microprocessor control these steps, with optional real-time I/O communication to a remote computer.

FIG. 8. Schematic diagram of a proposed sampling setup for the autonomous, real-time helium isotope detector, as example. This setup is at a non-pumping, perhaps abandoned, groundwater wellhead. For an active, pumped groundwater wellhead, preset amounts of water can be pumped into the gas-tight accumulation chamber to create a headspace so that Henry's Law can operate, or an emersion method based upon the embodiment illustrated in FIG. 4 can be used, either detached from 25 with a flexible vacuum hose connection or as an entire in situ instrument. Several electrical cables are not shown for figure clarity. Diagram is not to scale. Instrument DC power is provided over an insulated cable 77 from batteries charged by solar panels or through an AC-DC inverter from the power grid (not shown). Communications for data telemetry (also not shown) and any desired computer program changes as uploads are provided by fast Ethernet cable 78. A gas-tight pump 79 re-circulates gas through gas-tight flexible metal hose 80 between the accumulation chamber 81 and the outer metal gas-tight case 18 of the sample housing. A three-way solenoid valve 82 directs gas flow as re-circulating or toward the exit to atmosphere 83. In this embodiment, a gasket seal 84 is made at the base of the accumulation chamber. Wellhead temperature, pressure sensors 85 are located on top of the accumulation chamber. The chamber rests over the well pipe encased within the wellhead pad 86. The well pipe contains standing groundwater 87 at some level and a headspace gas in equilibrium with the water 88 that is sampled.

### Objects and Advantages

Lowered cost.

Sampling in remote locations.

Sampling in environments from near vacuum to full ocean depths.

Sampling in near real time.

Sampling autonomously.

Preprocessing data to lower communication link bandwidth.

Sample sequestration for later lab analysis.

Introducing calibration standards in the field.

In situ field sampling.

Sampling in harsh environments.

High mass resolution sampling.

Sampling from pressurized water.

Sampling from non pressurized water.

### DETAILS OF THE INVENTION

A prototype of the instrument has been designed, fabricated and tested. Even the proof-of-concepts, bench-top prototype is relatively low power, compact and rugged. The design can be scaled and optimized for more compact and rugged instrumentation. Sketches of some of the current embodiments of the invention are presented in the figures (FIGS. 1-4). Helium and hydrogen gas will diffuse through a glass membrane following Fick's Law:

αc/αt=D∇²c,

where C, the concentration of gas within the solid, varies with time and distance through a unit of cross section, and D is the diffusion constant. In the case of permeation of gas through a solid (or slow moving liquid such as glass), the concentration gradient in Fick's Law can be expressed as a pressure gradient, so that Fick's Law becomes:

K∇²ρ=0,

where K is the permeation constant, equal to the product of the solubility S and the diffusion constant D (as described by Altemose, V. O., 1961, “Helium diffusion through glass”, J. Appl. Phys. 32, 1309-1316; doi: 10.1063/1.1736226, which is hereby incorporated as reference). For a plane membrane, with pressure gradient p, cross-sectional area A, and thickness d, the quantity of gas q per unit time t, to pass through it is given by:

q=KAΔpt/d

Spherical samples where d is small compared with the radius of the sphere also reduce to the above equation (Altemose, 1961).

To obtain a high value of q, the principal features of the method and invention include:

1) A quartz glass window comprising the quartz glass membrane. This quartz glass window is composed of either natural or artificial quartz glass composition, that is of high purity for greater diffusion of helium and hydrogen gases. No other gases can permeate the glass window to add to the Ultra High Vacuum (UHV) (Altemose, 1961).

2) A quartz glass window that is thin (small d), within the practical range of 0.5 to 2 mm wall thickness, to allow a greater diffusion of helium and hydrogen gases.

3) A quartz glass window that has high surface area (large A), in either flat sheet, spherical, cylindrical or other tubular forms that allow greatest exposure of the sample gas to the window. Herein, the cylindrical window geometry was chosen over other possible shapes, as it was commercially available and less complex to manufacture than the more optimal designs known to us (FIG. 5).

4) A quartz glass window that is sealed to a vacuum chamber so that an ultra high vacuum (UHV) can be attained.

5) A quartz glass window that is heated, from ambient temperatures (0-45° C.) to temperatures of several hundred degrees C., so that diffusion of helium and hydrogen gases is enhanced, with helium diffusion at rates 45 times greater than hydrogen as H2 at 512° C. (as described by Taylor, N. W. and Rast, W., 1938, “The diffusion of helium and of hydrogen through Pyrex chemically resistant glass”, J. Chem. Phys. 6, 612-619; doi: 10.1063/1.1750133, which is herby incorporated as reference; and by Rogers, W. A., Buritz, R. S., and Alpert, D., 1954, “Diffusion coefficient, solubility, and permeability for helium in glass”, J. Appl. Phys. 25, 868-875; doi: 10.1063/1.1721760, which is herby incorporated as reference).

Other important components of the method and invention include:

1) A mass spectrometer, with high enough spectral resolution that the ³He peak can be easily separated from the ⁴He peak. A peak resolution of 100 M/dM or better is preferred, where M=mass in amu (Daltons).

2) Aa mass spectrometer, with the capability to frequency sweep or to collect electrometer peak spectral response for the ³He peak that can be easily separated from frequency sweep or electrometer collection of the spectral response of the ⁴He peak.

3) A mass spectrometer, with the ability to switch between analog and digital electrometer peak spectral response, for low-level, single ion counting of the ³He.

4) A mass spectrometer, with high scan speed, that is also compact, low-power and low in cost to purchase and maintain.

Further features include:

1) A non-evaporable getter (NEG) pump, that both maintains the ultra high vacuum and preferentially pumps hydrogen gas and other reactive, polar and non-polar gases but does not pump noble gases such as helium.

2) A non-evaporable getter pump, that can be purchased from a commercial vendor as a heated vacuum-mountable component, or can be made as a coating of titanium or palladium metal inside the UHV that has similar ability to preferentially pump hydrogen gas and other reactive, polar and non-polar gases but does not pump noble gases such as helium.

3) A small diode ion pump, that can be used as a UHV Total Pressure Gauge, while preferentially pumping hydrogen gas and other reactive, polar and non-polar gases but does not pump noble gases such as helium. A commercial HV or UHV gauge that does not pump noble gases can be used in place of, or in addition to, the small diode ion pump as a Total Pressure Gauge.

4) A noble diode ion pump, that is separated from the rest of the UHV by a manual or automated UHV valve (bellows, gate valve or similar) which can pump both noble gases such as helium and hydrogen gas and other reactive, polar and non-polar gases.

5) A purge vacuum port with UHV cutoff valve, to periodically connect the UHV to a portable vacuum station, usually equipped with a turbomolecular-roughing pump and a commercial, full-range atmosphere to HV or UHV pressure gauge for maintenance of the NEG and ion pumps. This port also provides for small sample or standards introduction to the UHV (see FIG. 6).

6) An embedded computer and microprocessor with associated circuit boards to record environmental sensors (e.g., ambient temperature, pressure) compute and record mass spectral and total pressure data, run programmed heat ramps and duration, run gas circulation pumps, control automatic opening and closing of UHV valves, and I/O communicate with remote computers via Ethernet and external modem links.

Principles of Operation:

Referring to the flow chart of major operational steps (FIG. 7), helium gas in the environment can either be directly measured in gaseous samples, by skipping the Henry's Law portion of step a, or in dissolved form, by sampling the isolated and hermetically-sealed head space gas in equilibrium above the liquid at STP, with the measured ambient temperature and barometric pressure for correction to STP (step a) (FIG. 8). Circulation of the gas to be measured over the detector housing can be accomplished by use of a small and low-power gas pump, such as a diaphragm pump, in a closed loop (step b). Helium sampling is accomplished by heating the quartz window from temperatures where very little helium and hydrogen gas is introduced into the UHV (0-45° C.) to temperatures above 100° C. (step c).

At temperatures from ca. −80° C. to up to 800° C., helium will diffuse through the glass at increasing rates (as described by Norton, F. J., 1953, “Helium diffusion through glass”, J. of the American Ceramic Society, 36(3), 90-96, which is hereby incorporated as reference; and by Taylor and Rast (1938); and by Rogers et al., 1954; and by Altemose, 1961). Once the heating ramp is complete and held for a user-specified amount of time, cooling the glass window back to temperatures of 0-45° C. effectively closes the UHV to further helium (and hydrogen) gas diffusion (step d). The sample is now trapped within the UHV and will dominate the vacuum pressure above background gases until they are removed.

Environmental hydrogen gas that diffuses along with helium through the quartz glass window plus any hydrogen that outgases from the materials within the UHV is quickly removed by the NEG pump. Removal of hydrogen gas both lowers the pressure within the UHV, thus concentrating the helium gas analyte, and removes HD, a minor molecular form of hydrogen gas that poses an important isobaric interference with low-abundance ³He measurement by mass spectrometry (as described by Burnard, P., Zimmerman, L. and Sano, Y., 2012, “The noble gases as geochemical tracers: history and background”, in Burnard, P. (ed.) The Noble Gases as Geochemical Tracers, Advances in Isotope Geochemistry, Springer, Berlin, 1-15, which is hereby incorporated as reference). Tritium (³H) poses another potential isobaric interference with ³He measurement by mass spectrometry, but is generally in extremely low environmental abundance and would also be quickly removed by the NEG pump.

Helium isotope analysis (step e) can be accomplished by a small, compact, low-power and low cost mass spectrometer with only modest peak resolution of 100 to 200 M/dM because no HD is present to interfere with the low-abundance ³He measurement. The need for a large and expensive mass spectrometer with peak resolution of greater than 600 M/dM to resolve HD (and ³H) from ³He is obviated by the disclosed design. Absolute partial pressures of ³He and ⁴He stable isotopes are calculated based upon the relative peak spectral response of the mass spectrometer and the total UHV pressure, as measured by the small diode ion pump or a commercial HV or UHV gauge that does not pump noble gases.

A programmed, embedded PC computes and records the isotopic, total pressure, and the temperature profile data onto flash memory (step f). The same embedded PC and associated circuit boards (CBs) also control the pumped gas circulation cycle, heat ramp and duration, and UHV valve open/close operation (i.e., step g) as well as record the pertinent environmental parameters (e.g., ambient temperature, pressure, seismicity, tilt).

Next, the UHV valve isolating the noble diode ion pump is opened and the helium gas is sequestered (step g). The ₄He partial pressure is monitored and recorded (step h). If the helium gas concentration is below a set threshold, the UHV valve is closed (step j) and (if this option is chosen) the data are telemetered to the base PC (step l). If the helium gas concentration is above the set threshold, the sample collection is stopped (step k), the results telemetered to base (step l), and the instrument is shut down (step n). If the sample collection is not stopped, the instrument waits for a user-specified amount of time and repeats the sample collection steps (Step o, FIG. 7).

### SUMMARY OF OPERATION

Disclosed is an improved compact, portable ³He/⁴He stable isotope detector and means for efficiently making precise and sensitive measurements of the isotopic abundance of ³He and ⁴He stable isotopes from gas or fluid samples at pressures varying from high vacuum to atmospheric to full ocean depth equivalence, of greater than 650 bars hydrostatic. Transmittance is through a heated quartz glass membrane shaped as a disc, hollow sphere, hollow cylinder, or a set of multiple hollow cylinders. This heated quartz glass membrane has pressure backing support consisting of: no pressure backing support, pressure backing support of a sintered metal structure, pressure backing support of a sintered ceramic structure, pressure backing support of a metal structure drilled with holes, or pressure backing support of a metal structure with machined slots. This pressure backing support provides additional pressure support permitting the heated quartz glass membrane to withstand the hydrostatic pressure of the contained sample and provide ease of transmittance of selected gases as molecular flow into the surrounding vacuum chamber. It is comprised of two major sub components consisting of the sampler housing with the heated quartz glass membrane, and a chamber with the mass spectrometer, vacuum components, and electronics. These major subcomponents are separated by a vacuum bulkhead.

This stable isotope detector provides improvements of: lower cost, compact size, lower power requirements, field portability, near real time data output, autonomous operation, telemetry capability, operation from near vacuum to full ocean depths, sample sequestration for later lab analysis, high sensitivity, ruggedized for harsh environments, internal data recording, sampling from pressurized water, sampling from non pressurized water, and in situ operation.

The unit has three basic configurations. A horizontal sampler housing chamber for sampling from gases consisting of: a gas-tight metal housing, a gas sample in port, a gas sample out port, heater and temperature electrical feed-thrus, an endcap, a spiral of a predetermined number of coils of metal tubing with a series of small egress holes facing the glass window port assembly, a quartz glass membrane assembly, a heater jacket, a temperature sensor, a perforated metal support cage, and a metal vacuum bulkhead.

A vertical sampler housing chamber for sampling from gases consisting of: a gas-tight metal housing, a gas sample in port, a gas sample out port, heater and temperature electrical feed-thrus, an endcap, a gas flow damper, a circular diffuser surrounding the quartz glass membrane assembly, a quartz glass membrane assembly, a heater jacket, a temperature sensor, a perforated metal support cage, and a metal vacuum bulkhead. The gas flow damper is used to adjust the exit gas flow rate providing regulation of the glass membrane temperature and regulation of desired gas transmittance through the glass membrane.

A horizontal sampler housing chamber for sampling from fluids consists of a gas and fluid-tight metal housing, a fluid sample in port, a fluid sample out port, fluid and water proof heater and temperature electrical feed-thrus, an endcap, a heater jacket, a temperature sensor, and a metal vacuum bulkhead. It further includes a glass port assembly comprised of a quartz glass tube over a porous sintered pressure support which in high pressure applications has additional pressure support provided by an inner metallic cylinder with drilled holes or machined slots providing the ease of transmittance of selected gases as molecular flow into the surrounded vacuum chamber in which said assemblage provides for samples with relatively high hydrodynamic pressures.

The horizontal sampler housing chamber for sampling from gases provides for selective separation of helium and hydrogen into the vacuum chamber from gaseous samples. The vertical sampler housing chamber for sampling from gases provides for selective separation of helium and hydrogen into the vacuum chamber from gaseous samples. The horizontal sampler housing chamber for sampling from fluids provides for selective separation of helium and hydrogen into the vacuum chamber from fluid and or water samples.

The chamber with the mass spectrometer, vacuum components, and electronics consists of: a sample collection unit, a mass spectrometer, a high vacuum chamber, a non-evaporable getter pump, a diode ion pump, a noble diode ion pump, a purge vacuum port with ultra high vacuum valve, ultra high vacuum total pressure gauge, electronics, wiring, solenoid valves, controls, temperature and pressure sensors, and an embedded computer and microprocessor. The sample collection unit consists of: an ultra high vacuum valve, two solenoid valves, tubing and interconnections, two UltraTorr™ valves, a gas tight tubing clamp, and an end crimped copper tubing. The sample collection unit provides for sequestering of a predetermined sample within a section of copper tubing which can be gas tight crimped and removed for further in lab analysis. The mass spectrometer provides for spectrum analysis of the sample within the high vacuum chamber. The high vacuum chamber consists of the free space of the interconnected vacuum components of this apparatus. The non-evaporable getter pump maintains the ultra high vacuum and preferentially pumps hydrogen gas and preferentially pumps other reactive polar gases and preferentially pumps other reactive non-polar gases but does not pump noble gases such as helium. The diode ion pump preferentially pumps hydrogen gas and preferentially pumps other reactive polar gases and preferentially pumps other reactive non-polar gases but does not pump noble gases such as helium. The noble diode ion pump is selectively separated or connected to the high vacuum chamber by a manual or automated ultra high vacuum valve. The noble diode ion pump can pump both noble gases such as helium and hydrogen gas and other reactive polar gases and other reactive non-polar gases. The purge vacuum port with ultra high vacuum valve provides for periodic connection of the high vacuum chamber to a portable vacuum station, introduction of small sample standards to the high vacuum chamber, and sequestration of small sample standards from the high vacuum chamber. The embedded computer and microprocessor record data from environmental sensors including temperatures and pressures; compute and record mass spectral and total pressure data; control preprogramed operation of heat ramps, gas circulation pumps, opening and closing of valves, execution of input and output, and communicate with remote computers via ethernet and external remote communication links.

The heated quartz glass membrane functions as a quartz window between the sample chamber and the high vacuum chamber providing selective transmittance of hydrogen and helium gases as molecular flow into this vacuum chamber. It is impermeable to all other gases other than hydrogen and helium and provides for exclusive transmittance of hydrogen and helium into the high vacuum chamber. The rate of hydrogen transmittance differs from the rate of helium transmittance. The rate of helium transmittance through the glass window is affected by the purity of the quartz glass, the thickness of the quartz glass wherein helium diffusion increases inversely with thickness, the surface area of the quartz glass window wherein diffusion increases proportionally with surface area, with the pressure differential across the quartz glass window wherein diffusion increases proportionally with increased pressure differential, with temperature wherein diffusion increases proportionally with increases in temperature. The differential diffusion of helium becomes greater than that of hydrogen with increased temperature. The helium diffusion rate is 45 times greater than molecular hydrogen at 512 degrees Celsius.

The mass spectrometer functions to measure the abundance of gas species by mass. Desirable performance characteristics of said mass spectrometer include: High spectral resolution with sufficient spectral resolution to resolve helium 3 verses helium 4. A resolution of 100 M/dM or better where M is mass in Daltons. The ability to produce and analog output representation of abundance. The ability to produce a digital output based on pulse hight. High scan speed, compact size, low power consumption, low cost, and high dynamic range.

The vacuum bulkheads comprises a circular metallic structure capable of withstanding the applied hydrodynamic differential pressure. The vacuum bulkhead provides a mounting location for: the sampler housing, the chamber with the mass spectrometer, vacuum components, and electronics, the ultra high vacuum purge port, the vacuum port to the noble diode ion pump, the port for the non-evaporable getter pump, the port for the diode ion pump, and the port for the mass spectrometer.

This improved compact, portable ³He/⁴He stable isotope detector functions by the following operations: A sample is introduced into the sample chamber. The quartz glass window is heated to a predetermined temperature and this heated quartz glass window provides for exclusive diffusion of helium and hydrogen. With higher temperatures the heated quartz glass window more preferentially diffuses helium.

The hydrogen gas diffused into the high vacuum chamber is selectively pumped and sequestered by the non-evaporable getter pump. The heating of the quartz glass window is stopped after a predetermined amount of time with cooling the quartz glass window below 45 degrees Celsius effectively closing the quartz glass window to further hydrogen and helium diffusion. The mass spectrometer measures the helium 3 and helium 4 abundance and electronics calculates and records the helium 3 to helium 4 ratio. The ultra high vacuum valve opens and exposes the vacuum chamber to the noble diode ion pump and the noble diode ion pump pumps and sequesters the helium gas level to below a set threshold as measured by the ultra high vacuum total pressure gauge. The apparatus is now prepared to receive another sample and the process is repeated. In the event that the helium is not pumped by the noble diode ion pump to below the set threshold in a predetermined amount of time such an indication is recorded. If telemetry is available this indication of not reaching a predetermined helium threshold level is telemetered the unit is then shut down.

These improved means of making precise and sensitive measurements of the isotopic abundance of ³He and ⁴He stable isotopes from gas or fluid samples provide: lowered cost, sampling in remote locations, sampling in environments from near vacuum to full ocean depths, sampling in near real time, sampling autonomously, preprocessing data to lower communication link bandwidth, sample sequestration for later lab analysis, introducing calibration standards in the field, in situ field sampling, sampling in harsh environments, high mass resolution sampling, sampling from pressurized water, and sampling from non pressurized water.

### Conclusion, Ramifications, and Scope

This improved compact, portable ³He/⁴He stable isotope detector and means for efficiently making precise and sensitive measurements of the isotopic abundance of ³He and ⁴He stable isotopes from gas or fluid samples at pressures varying from high vacuum to atmospheric to full ocean depth equivalence, of greater than 650 bars hydrostatic. It is small, efficient, rugged, autonomous providing a unit for field survey work and monitoring. It has three embodiments. A horizontal sampler housing chamber for sampling from gases provides for selective separation of helium and hydrogen into the vacuum chamber from gaseous samples. A vertical sampler housing chamber for sampling from gases provides for selective separation of helium and hydrogen into the vacuum chamber from gaseous samples. A horizontal sampler housing chamber for sampling from fluids provides for selective separation of helium and hydrogen into the vacuum chamber from fluid and or water samples.

In the descriptions above, we have put forth theories of operation that we believe to be correct, such as the making precise and sensitive measurements of the isotopic abundance of ³He and ⁴He stable isotopes. While we believe these theories to be correct, we don't wish to be bound by them. While there have been described above the principals of this invention in connection with specific apparatus, it is to be clearly understood that this description is made only by way of example and is not as a limitation to the scope of the invention. Other embodiments of these approaches to efficient dissolved gas and volatile organic compound transmittance from a fluid will be apparent to those skilled in the art from consideration of the specification and practice of the invention disclosed herein. It is intended that the specification be considered as exemplary only, with the true scope and spirit of the invention being indicated by the appended claims and their legal equivalents, rather than by the examples given.

I claim:

1. An improved apparatus of a compact, portable ³He/⁴He stable isotope detector for efficiently making precise and sensitive measurements of the isotopic abundance of ³He and ⁴He stable isotopes from gas or fluid samples at pressures varying from high vacuum to atmospheric to full ocean depth equivalence, of greater than 650 bars hydrostatic, wherein transmittance is through a heated quartz glass membrane wherein the shape of said heated quartz glass membrane is selected from the group consisting of:
1) a disc,
2) a hollow sphere,
3) a hollow cylinder,
4) a set of multiple hollow cylinders,
5) or a mixture thereof;
wherein said heated quartz glass membrane has pressure backing support wherein the means of said pressure backing support is selected from the group consisting of:
1) no pressure backing support,
2) pressure backing support of a sintered metal structure,
3) pressure backing support of a sintered ceramic structure,
4) pressure backing support of a metal structure drilled with holes,
5) pressure backing support of a metal structure with machined slots,
6) or a mixture thereof;
wherein said pressure backing support provides additional pressure support permitting the heated quartz glass membrane to withstand the hydrostatic pressure of the contained sample; wherein these means provide for ease of transmittance of selected gases as molecular flow into the surrounding vacuum chamber.

2. An improved means of making precise and sensitive measurements of the isotopic abundance of ³He and ⁴He stable isotopes from gas or fluid samples at pressures varying from high vacuum to atmospheric to full ocean depth equivalence, of greater than 650 bars hydrostatic, wherein transmittance is through a heated quartz glass membrane wherein the shape of said heated quartz glass membrane is selected from the group consisting of:
1) a disc,
2) a hollow sphere,
3) a hollow cylinder,
4) a set of multiple hollow cylinders,
5) or a mixture thereof;
wherein said heated quartz glass membrane has pressure backing support wherein the means of said pressure backing support is selected from the group consisting of:
1) no pressure backing support,
2) pressure backing support of a sintered metal structure,
3) pressure backing support of a sintered ceramic structure,
4) pressure backing support of a metal structure drilled with holes,
5) pressure backing support of a metal structure with machined slots,
6) or a mixture thereof;
wherein said pressure backing support provides additional pressure support permitting the heated quartz glass membrane to withstand the hydrostatic pressure of the contained sample; wherein these means provide for ease of transmittance of selected gases as molecular flow into the surrounding vacuum chamber.

3. The improved ³He/⁴He stable isotope detector of claim 1 wherein said improved ³He/⁴He stable isotope detector is comprised of two major sub components consisting of: a sampler housing and heated quartz glass membrane; a chamber with the mass spectrometer, vacuum components, and electronics; wherein said two major subcomponents are separated by a vacuum bulkhead.

4. The improved ³He/⁴He stable isotope detector of claim 1 wherein said improved ³He/⁴He stable isotope detector provides for one or more improvements selected from the group consisting of:
1) lowered cost,
2) compact size,
3) low power requirements,
4) field portable,
5) near real time data output,
6) autonomous operation,
7) telemetry capability,
8) operation from near vacuum to ocean depth pressures,
9) sample sequestration for later lab analysis,
10) high sensitivity,
11) ruggedized for harsh environments,
12) internal data recording,
13) sampling from pressurized water,
14) sampling from non pressurized water
15) in situ operation,
16) or a mixture thereof.

5. The improved ³He/⁴He stable isotope detector of claim 1 wherein said improved ³He/⁴He stable isotope detector has one of three configurations selected from the group consisting of:
1) a horizontal sampler housing chamber for sampling from gases,
2) a vertical sampler housing chamber for sampling from gases,
3) a horizontal sampler housing chamber for sampling from fluids,
wherein said horizontal sampler housing chamber for sampling from gases consists of: a gas-tight metal housing, a gas sample in port, a gas sample out port, heater and temperature electrical feed-thrus, an endcap, a spiral of a predetermined number of coils of metal tubing with a series of small egress holes facing the glass window port assembly, a quartz glass membrane assembly, a heater jacket, a temperature sensor, a perforated metal support cage, and a metal vacuum bulkhead; wherein said vertical sampler housing chamber for sampling from gases consists of: a gas-tight metal housing, a gas sample in port, a gas sample out port, heater and temperature electrical feed-thrus, an endcap, a gas flow damper, a circular diffuser surrounding the quartz glass membrane assembly, a quartz glass membrane assembly, a heater jacket, a temperature sensor, a perforated metal support cage, and a metal vacuum bulkhead; wherein said gas flow damper is used to adjust the exit gas flow rate providing for: regulation of the glass membrane temperature and regulation of desired gas transmittance through the glass membrane; wherein said horizontal sampler housing chamber for sampling from fluids consists of: a gas and fluid-tight metal housing, a fluid sample in port, a fluid sample out port, fluid and water proof heater and temperature electrical feed-thrus, an endcap, a glass port assembly comprised of a quartz glass tube over a porous sintered pressure support which in high pressure applications has additional pressure support provided by an inner metallic cylinder with drilled holes or machined slots providing the ease of transmittance of selected gases as molecular flow into the surrounded vacuum chamber in which said assemblage provides for samples with relatively high hydrodynamic pressures, a heater jacket, a temperature sensor, and a metal vacuum bulkhead; wherein said horizontal sampler housing chamber for sampling from gases provides for selective separation of helium and hydrogen into the vacuum chamber from gaseous samples; wherein said vertical sampler housing chamber for sampling from gases provides for selective separation of helium and hydrogen into the vacuum chamber from gaseous samples; wherein said horizontal sampler housing chamber for sampling from fluids provides for selective separation of helium and hydrogen into the vacuum chamber from fluid and or water samples.

6. The chamber with the detector, vacuum components, and electronics of claim 3 wherein said chamber with the mass spectrometer, vacuum components, and electronics consists of: a sample collection unit, a mass spectrometer, a high vacuum chamber, a non-evaporable getter pump, a diode ion pump, a noble diode ion pump, a purge vacuum port with ultra high vacuum valve, ultra high vacuum total pressure gauge, electronics, wiring, solenoid valves, controls, temperature and pressure sensors, and an embedded computer and microprocessor; wherein said sample collection unit consists of: an ultra high vacuum valve, two solenoid valves, tubing and interconnections, two UltraTorr™ valves, a gas tight tubing clamp, and an end crimped copper tubing; wherein said sample collection unit provides for sequestering of a predetermined sample within a section of copper tubing which can be gas tight crimped and removed for further in lab analysis; wherein said mass spectrometer provides for spectrum analysis of the sample within the high vacuum chamber; wherein said high vacuum chamber consists of the free space of the interconnected vacuum components of this apparatus; wherein said non-evaporable getter pump maintains the ultra high vacuum and preferentially pumps hydrogen gas and preferentially pumps other reactive polar gases and preferentially pumps other reactive non-polar gases but does not pump noble gases such as helium; wherein said diode ion pump preferentially pumps hydrogen gas and preferentially pumps other reactive polar gases and preferentially pumps other reactive non-polar gases but does not pump noble gases such as helium; wherein said noble diode ion pump is selectively separated or connected to the high vacuum chamber by a manual or automated ultra high vacuum valve; wherein said noble diode ion pump can pump both noble gases such as helium and hydrogen gas and other reactive polar gases and other reactive non-polar gases; wherein said purge vacuum port with ultra high vacuum valve provides for: periodic connection of the high vacuum chamber to a portable vacuum station, introduction of small sample standards to the high vacuum chamber, and sequestration of small sample standards from the high vacuum chamber; wherein said embedded computer and microprocessor provide for: recording data from environmental sensors including temperatures and pressures, computation of mass spectral and total pressure data, recording of mass spectral and total pressure data, control of preprogramed operation of heat ramps, control of gas circulation pumps, control of opening and closing of valves, execution of input and output functions, and communication with remote computers via ethernet and external remote communication links.

7. The heated quartz glass membrane of claim 1 wherein said heated quartz glass membrane functions as a quartz window between the sample chamber and the high vacuum chamber; wherein said quartz glass window provides for selective transmittance of hydrogen and helium gases as molecular flow into said vacuum chamber; wherein said quartz glass window is impermeable to all other gases other than hydrogen and helium; wherein the rate of hydrogen transmittance differs from the rate of helium transmittance; where the rate of helium transmittance through the glass window is affected by: the purity of the quartz glass, the thickness of the quartz glass wherein helium diffusion increases inversely with thickness, the surface area of the quartz glass window wherein diffusion increases proportionally with surface area, with the pressure differential across the quartz glass window wherein diffusion increases proportionally with increased pressure differential, with temperature wherein diffusion increases proportionally with increases in temperature and wherein the differential diffusion of helium becomes greater than that of hydrogen with increased temperature whereby the helium diffusion rate is 45 times greater than molecular hydrogen at 512 degrees Celsius; wherein said heated quartz glass membrane provides for exclusive transmittance of hydrogen and helium into the high vacuum chamber.

8. The mass spectrometer of claim 3 wherein said mass spectrometer functions to measure the abundance of gas species by mass; wherein performance characteristics of said mass spectrometer include: high spectral resolution, sufficient spectral resolution to resolve helium 3 verses helium 4, a resolution of 100 M/dM or better where M is mass in Daltons, the ability to produce and analog output representation of abundance, the ability to produce a digital output based on pulse hight, high scan speed, compact size, low power consumption, low cost, and high dynamic range.

9. The vacuum bulkhead of claim 3 wherein said vacuum bulkheads comprises a circular metallic structure capable of withstanding the applied hydrodynamic differential pressure; wherein said vacuum bulkhead provides a mounting location for: the sampler housing, the chamber with the mass spectrometer, vacuum components, and electronics, the ultra high vacuum purge port, the vacuum port to the noble diode ion pump, the port for the non-evaporable getter pump, the port for the diode ion pump, and the port for the mass spectrometer.

10. Improved apparatus of a compact, portable ³He/⁴He stable isotope detector of claim one functions by the following operations: a sample is introduced into the sample chamber, the quartz glass window is heated to a predetermined temperature, the heated quartz glass window provides for exclusive diffusion of helium and hydrogen, with higher temperatures the heated quartz glass window more preferentially diffuses helium, the hydrogen gas diffused into the high vacuum chamber is selectively pumped and sequestered by the non-evaporable getter pump, the heating of the quartz glass window is stopped after a predetermined amount of time, cooling of the quartz glass window below 45 degrees Celsius effectively closes the quartz glass window to further hydrogen and helium diffusion, the mass spectrometer measures the helium 3 and helium 4 abundance, electronics calculates and records the helium 3 to helium 4 ratio, the ultra high vacuum valve opens and exposes the vacuum chamber to the noble diode ion pump, the noble diode ion pump pumps and sequesters the helium gas level to below a set threshold as measured by the ultra high vacuum total pressure gauge, the apparatus is now prepared to receive another sample, the process is repeated, in the event that the helium is not pumped by the noble diode ion pump to below the set threshold in a predetermined amount of time such an indication is recorded, if telemetry is available this indication of not reaching a predetermined helium threshold level is telemetered the unit is then shut down.

11. The improved means of of making precise and sensitive measurements of the isotopic abundance of ₃He and ₄He stable isotopes from gas or fluid samples of claim 2 wherein said improved means of of making precise and sensitive measurements of the isotopic abundance of ³He and ⁴He stable isotopes from gas or fluid samples include one or more improved means selected from the group consisting of:
1) a means lowered cost,
2) a means of sampling in remote locations,
3) a means of sampling in environments from near vacuum to full ocean depths,
4) a means of sampling in near real time,
5) a means of sampling autonomously,
6) a means of preprocessing data to lower communication link bandwidth,
7) a means sample sequestration for later lab analysis,
8) a means of introducing calibration standards in the field,
9) a means of in situ field sampling,
10) a means of sampling in harsh environments,
11) a means of high mass resolution sampling,
12) a means of sampling from pressurized water,
13) a means of sampling from non pressurized water,
14) or a mixture thereof.
